(19) United States
(12) Patent Application Publication
(10) Pub. No.: US 2010/0139946 A1
(43) Pub. Date: Jun. 10, 2010

(54) SELF-ASSEMBLED NANOPARTICLES-NANOTUBE STRUCTURES BASED ON ANTENNA CHEMISTRY OF CONDUCTIVE NANORODS

(75) Inventors: Howard K. Schmidt, Cypress, TX (US); Juan G. Duque, Houston, TX (US); Matteo Pasquali, Houston, TX (US)

Correspondence Address: WINSTEAD PC, P.O. BOX 50784, DALLAS, TX, 75201, US

(73) Assignee: WILLIAM MARSH RICE UNIVERSITY, Houston, TX (US)

(21) Appl. No.: 12/520,627

(22) PCT Filed: Dec. 20, 2007
(86) PCT No.: PCT/US2007/088428

§ 371 Date: Mar. 1, 2010

Related U.S. Application Data
(60) Provisional application No. 60/875,907, filed on Dec. 20, 2006.
(60) Provisional application No. 60/991,052, filed on Nov. 29, 2007.
(60) Provisional application No. 61/007,061, filed on Dec. 11, 2007.

(51) Int. Cl. H01B 5/00; B05D 5/12

(52) U.S. Cl. 174/126.1; 427/58

(57) ABSTRACT

The present invention relates in general to nanostructured materials and processes for making same. More particularly, the present inventions relates to a nanoscale composite structure and methods for making same involving a conductive nanorod comprising a tip at each of the nanorod extrema; and a material deposited on at the least the tips, wherein the material comprises a reduced form of a redox species, wherein the redox species is adapted for electrochemical reaction with the conductive nanorod when the conductive nanorod is stimulated as an antenna by an electric field.

### STATEMENT OF GOVERNMENT SPONSORSHIP

The present invention was made in part with United States Government support under a grant awarded by NASA, Grant No. NNJ05HE75A through a subcontract from University of Texas Health Science Center. The U.S. Government has certain rights in this invention.

### FIELD OF INVENTION

The present invention relates in general to nanostructured materials and processes for making same.

### BACKGROUND OF INVENTION

There has been continuing interest in nanostructured materials that incorporate nanotubes in contact with metals. An exemplary application has been electronics. However, despite continuing efforts, there remains a need for improved nanostructured composite materials based on nanotubes.

### BRIEF DESCRIPTION OF INVENTION

According to some embodiments of the present invention, a nanoscale composite structure comprises: a conductive nanorod comprising a tip at each of the nanorod extrema; and a material deposited on at the least the tips, wherein the material comprises a reduced form of a redox species, wherein the redox species is adapted for electrochemical reaction with the conductive nanorod when the conductive nanorod is stimulated as an antenna by an electric field.

According to some other embodiments of the present invention, a method for chemically modifying a conductive nanorod comprising: mixing a redox species with the conductive nanorod in a solution; stimulating the conductive nanorod as an antenna with an electric field, wherein the conductive nanorod comprises a tip at each of the nanorod extrema; allowing the redox species to electrochemically react with the conductive nanorod when stimulating the conductive nanorod with the electric field; and depositing a material comprising a reduced form of the redox species on the tips so as to form a nanoscale composite structure.

### BRIEF DESCRIPTION OF DRAWINGS

The foregoing brief description of the invention as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 shows an AFM image illustrating a exemplary dumbbell structure;

FIG. 2 shows a comparative AFM image for comparison with FIG. 1;

FIG. 3 shows an AFM image illustrating an exemplary ring structure;

FIG. 4 shows an AFM image illustrating an exemplary split ring structure;

FIG. 5 shows an AFM image illustrating an exemplary partially encapsulated structure;

FIG. 6 shows a comparative AFM image for comparison with FIG. 5;

FIG. 7 shows an AFM image illustrating an exemplary covered structure;

FIG. 8 shows an AFM image illustrating an exemplary dumbbell structure obtained under different conditions than that of FIG. 1;

FIG. 9 shows a comparative AFM image for comparison with FIG. 8;

FIG. 10 shows an AFM image illustrating an exemplary ring structure having no metal;

FIG. 11 shows an AFM image illustrating an exemplary ring structure adorned with metal;

FIG. 12 shows an AFM image illustrating an exemplary ring structure covered with metal;

FIG. 13 shows an AFM image illustrating an exemplary ring on a stick structure;

FIG. 14 shows exemplary fluorescence spectra for detecting electron transfer between nanotubes and various metal ion salts;

FIG. 15 shows exemplary Fluorolog spectra for detection of ROS;

FIG. 16 shows an exemplary plot illustrating faster rates of electron transfer for larger diameter nanotubes;

FIG. 17 illustrates SWNT redox properties and electric field interactions, with (a) Electric field structure around 1 nm×1 μm SWNT in a constant 1 V/μm field, with and without 3 nm surfactant layer, generated using Comsol 3.4, (b) Summary of comparative spontaneous and MW-stimulated nanoparticle formation using various combinations of metal salts and surfactants (dark=no particles; light=spontaneous particle formation), and (c) Estimated SWNT redox potentials;

FIG. 18 illustrates SWNT-Au nanoparticle morphologies, with (a-b) Representative AFM images of spontaneous and indiscriminate sidewall decoration (a) and tip selective (b) reduction of Au metal salts onto SWNTs by comparative thermal (a) and MW (b) reduction, (c) 3-D thermal and MW reduction of Au metal particles, (d) Absorbance of microwave driven reaction of SDBS-SWNT with different amounts of 1 mM HAuCl₄ (0 μL reference, black; 30 μL, red; 60 μL, green; 100 μL, blue; and 150 μL, light blue);

FIG. 19 illustrates SWNT selectivity in MW-driven redox reactions, with (a-b) Absorbance (a) and liquid-phase Raman using 660 nm excitation (b) spectra of SDBS-SWNT-Au suspensions after addition different amounts of 1 mM Au salt solutions (0 μL reference, black; 100 μL, blue; 300 μL, red; and 500 μL, green) and subsequent MW processing, (c) Integrated metallic fraction of the RBM as function of initial Au concentration;

FIG. 20 illustrates MW Electrodeposition kinetics of FeCl₃ on SWNT, with (a) Representative AFM images of MW induced reduction of Fe³⁺ metal ions, (b) Particle size distribution on the tips of individual SWNTs, (c) Representative AFM image of individual SWNT-metal complex with their respective vertical distance;

FIG. 21 is a histogram illustrating comparative spontaneous nanoparticle diameter statistics;

FIG. 22 shows exemplary spectra illustrating near infrared fluorescence of SDBS-SWNT with transition metal salts;

FIG. 23 shows exemplary Raman spectra illustrating metallic SWNT separation Raman analysis; and

FIG. 24 shows exemplary plots illustrating SWNT field emission modeling, with a. (a) bare SWNT, Φ=1.5V (blue); (b) SDBS-SWNT, Φ=4.7 V (red); (c) SDBS-SWNT, Φ=1.5V (yellow), b. (a) bare SWNT(blue); (b) SDBS-SWNT (red), c.

### DETAILED DESCRIPTION OF THE INVENTION

Generally, the present process includes, but is not limited to, mixing a redox reactant species with the SWNT (single-walled nanotube) solution and stimulating with alternating electric fields at RF (radiofrequency), MW (microwave) or optical frequencies. Various surfactant mixtures may be utilized to promote formation of rings. Further, by way of example, and not limitation, the following may be varied, as describe in more detail herein: frequency, CNT (carbon nanotube) types, reactant type, SWNT lengths, field strengths. For example, it will be understood that the frequency may be essentially zero, that is the electric field may be a DC electric field.

Conductive nanorods in solution are stimulated to generate nanostructures using alternating electric fields. If redox active species are supplied to the particle-carrying solution, the applied field may be used to cause reactions that generate useful and interesting nanostructures; these are typically composites of carbon nanorods with metallic or metal oxide nanoparticles. Even in the case where no reactive species are supplied, applied fields may generate specific nanostructures like rings and ring-on-stick structures from the starting nanorod materials.

Further, the present inventors found that at rather high electric fields (e.g. one volt per micron), single-wall carbon nanotubes may be induced to generate reactive oxygen species (ROS) in solution. We consider this to be proof of field emission of charge carriers from the nanorod tips directly into solution. Electrons are known to form solvated species that subsequently react with atmospheric di-oxygen to produce superoxide radical. This may react with other species to generate hydroxyl radical. Both of these are known as dangerous oxidizing species in biological systems.

The present inventors contemplate using one or both of single- and multi-wall carbon nanotubes. The examples are based on single-wall carbon nanotubes (SWNT), although the results are obviously applicable to any type of carbon nanotube, and indeed applicable to any elongated conductive particle (nano or micro) suspended in liquid solution. By elongated, the present inventors intend to mean particles with a length to width ratio greater than 2. The present inventors expect that field induced chemistry may proceed even on spherical particles at high electric fields.

The present inventors contemplate using carbon nanotubes suspended in fluids. The examples are based on individual SWNT as well as small bundles of SWNT suspended in water with various surfactants. The results are applicable to SWNT and other conductive particles truly dissolved in fluids, aqueous or not, as well as particles suspended as colloids.

The present inventors contemplate using conductive particles. In the case of SWNT these may be either metallic or semiconducting in nature; these are both conductive, although their conductivities are quite different. So, any particle with mobile charge carriers may be used in this process—this includes metallic conductors, semiconductors and superconductors.

The present inventors contemplate using alternating electric fields to minimize migration of the particles in the carrier fluid. The present inventors have successfully tested electric fields over a wide range of frequencies from low frequency RF at 2 MHz up to optical radiation at 220 nm wavelength. All of these have been shown to drive selective chemistries, and all are included. The lower bound of useful frequencies is may be determined by the migration time of particles to electrodes; this is determined by the strength of the electric field and the size of the particle (thus is hydrodynamic drag), and a useful lower bound is on the order of 0.001 Hz.

The electric fields applied that successfully induces chemistry on the conductive particles likewise spans a substantial range. In instances where the present process may include measuring or calculating the applied electric field, the present process may include operating in the range of about 0.001 to 10 volts per micron. The purpose of the applied electric field is to induce a voltage shift on the extrema of the suspended particles. Charge carriers in the particles move in response to the external field, and build up a concentration of charge at their extrema. Since the present process may include driving redox reactions, the present process may include building up charges and so potential differences between the particle extrema and the neighboring fluid of at least 0.001 volt, and more typically in the range of 0.100 volt or greater. Since the present particles are typically in the range of 1 micron in length, the present process may utilize fields that generate the suitable potential difference over one-half the length of the particle, e.g. 2 volts per micron generates a 1 volt potential shift at the tip of a 1 micron long particle (SWNT). Higher fields may be used for smaller particles and lower fields may be used for larger/longer particles. Even higher fields are certainly useful, and may be used to emit free charges into solution by field emission.

The present process is useful for generating nanotube-nanoparticle composite structures. The nanotubes may be induced to form ring structures as well as ring-on-stick structures. These actions may be combined to form nanotube-nanoparticle ring structures.

There are a variety of nanotube-nanoparticle structures observed. Usually these include nanoparticles deposited on the tips of nanotubes. In certain systems, the nanoparticles deposited on the tips may be induced to ‘grow’ down the length of the nanotube, generating partially encapsulated nanotubes. In extreme cases, this may be pushed to generate entirely encapsulated nanotubes, e.g. gold encapsulated SWNT. Many metals are readily oxidized at the nanoscale, and if these nanostructures are produced in an oxygenated fluid, the resulting particles may be readily obtained as metal oxides. Most of these are insulators, although some have moderate bandgaps and have interesting semiconducting properties. The size of the nanoparticles generated at the tips of the SWNT is controlled by the concentration of reactant, the applied field strength and the amount of time the reaction is allowed to proceed.

The field induced chemistry causes redox species that do not spontaneously react with SWNT in solution (e.g. copper, palladium and iron salts) to react and deposit particles thereon. The field induced chemistry generally causes deposition of nanoparticles on the tips of the SWNT. This means that the process is very general, and also allows the development of very highly dispersed nanoparticles. For example, the present process and nanostructured materials may be useful in the production of SWNT-supported palladium catalysts—these are useful in fuel cells and other catalytic reactions. The same may be said of many other catalytic materials. Even gold is known to display interesting and useful catalytic properties when dispersed as 1 nm particles or smaller. On most substrates, gold is subject to aggressive ripening, which defeats the catalytic value of the gold. Such SWNT-gold composites may be much more stable to ripening.

Although the examples shown are based on inorganic reactants, the present inventors contemplate using redox active organic species, of which many are known. If these contain olefinic groups, these may also be useful as polymerization agents, allowing the generations of polymers regiospecifically grafted to nanotube ends. These may be useful in catalytic, biological and composite materials applications.

The present inventors contemplate methods and nanostructures that may involve any one of exploring electromagnetic antenna effects in SWNT and developing a procedure to obtain high yields of SWNT nanostructures that respond to radio frequency (RF). Applications may include thermoablation therapy and the like.

Antennas are devices designed to transmit or receive electromagnetic (EM) waves which have wavelengths close to multiples of the length of the antenna. This is done by converting electrical current to electromagnetic waves and vice versa. For optimal performance, antennas are desirably constructed from highly conductive materials so that electrical charges can move with minimum resistance. Individual metallic SWNT are excellent conductors, and may serve as efficient EM absorbers.

The present inventors contemplate that controlled aggregation of SWNT may lead to efficient interaction with EM radiation of arbitrary wavelengths. The present inventors further contemplate that the high aspect ratio of SWNT will lead to chemical and physical effects arising from periodic charge concentrations at their tips in response to electromagnetic stimulation. Thus, the present inventors contemplate that, the present methods and nanostructure may be used to develop a) tunable absorbers for thermoablation, and b) explore EM-driven ion/radial generation processes potentially useful in cancer therapies.

The present inventors observed clear evidence that SWNT behave as antennas in the presence of light, microwaves and radio frequency fields. The present inventors also found a mechanism to produce high yields of SWNT rings and novel split-ring structures. The present inventors contemplate that these results support the idea that EM-stimulated therapies based on SWNT antennas are possible, and that tunable structures may be developed to optimize RF thermoablation therapies.

The present inventors anticipate that using SWNT, or similar elongated conductive particles, to generate free radicals in solution may be useful for a variety of applications. By way of example and not limitation, one application may be as a cytotoxic agent in healthcare. In conjunction with a targeting, or localization process, the present process may include stimulating the SWNT with body-penetratine electric fields to generate high concentrations of ROS. These may then have a toxic effect on local tissues. The fields may be localized further by using phased array electro-magnetic sources. This field emission mediated process may be non-linearly dependent (as all field emission processes, described by Fowler-Nordheim i-v curves are) on the applied field and the length of the antennas (length of SWNT). Further the present inventors expect that controlled precipitation/bundling of SWNT (by targeting multiple SWNT to a given target cell) may ‘construct’ antennae long enough to produce ROS, while individual SWNT may remain essentially inert under electric stimulation. By one or a combination of these means, the present process and nanostructured materials may readily achieve a very selective agent for destroying undesirable tissues, e.g. cancer, perhaps even at the level of individual cells. This may tend to be more desirable than the generalized cytotoxins or radiation-based treatments commonly used today.

The present inventors have found that microwave fields selectively drive regio-selective electrodeposition reactions on metallic single-wall carbon nanotubes in the presence of transition metal ions in solution; novel composite nanostructures are produced at near diffusion-limited rates via an apparent field emission mechanism. Further, the present inventors have achieved results from 2 MHz RF, short pulses of high voltage (1 kV/cm, with 30 microsecond full width half max), and also with broadband light irradiation.

Metallic single-wall carbon nanotubes (SWNTs) rapidly polarize to screen external electric fields, while their high aspect ratio greatly amplifies the apparent field strength at their extremities. The present inventors demonstrate that these electrodynamic effects can be exploited, for example in a laboratory microwave reactor, to drive electrochemical reactions with aqueous suspensions of individualized nanotubes. Experimental results provide evidence of selective activation of metallic SWNT and suggest a highly rectifying reaction mechanism involving long range tunneling or field emission directly into solution. In the presence of high oxidation potential transition metal salts like gold chloride or iron chloride, reductive condensation to metallic nanoparticles proceeds with near diffusion-limited kinetics. Particle deposition on the nanotubes is regio-specific to the SWNT extremities, yielding novel composite nanostructures. Nanotube antenna chemistry is remarkably facile, and could impact nanomedicine, energy harvesting and synthesis.

The present inventors also anticipate that SWNT-gold nanostructures may be useful in developing nanovectors for biological applications. SWNT are known for their RF/MW heating interactions, and are also well known for their fluorescence in the near IR (NIRF). Gold nanoparticles have long been used in biology in conjunction with targeting moities for decorating target tissues may gold nanoparticles which are easy to identify using TEM. Various chemistries for attaching biomolecules to gold nanoparticles are well known and well developed. Targeting and functional chemistries for SWNT are less well developed, and most of the effort in this area has been based on covalent functionalizations that destroy the intrinsic electronic properties of the SWNT. Using SWNT-Au nanocomposites therefore, the present process and nanostructured materials may combine the flexible array of functionality already developed for gold nanoparticles and rapidly gain functionality for SWNT systems that may be useful for RF/MW thermoablation as well as NIRF imaging and tracking.

SWNT rings have been reported in the literature before, but the present inventors know of no process known or reported for generating rings of individual SWNT with controlled diameter, minimal overlap and high yield. The present process delivers all of these features. The present inventors believe that the present rings have 5-10 nm of overlap that holds the ring together by van der Waals forces. The energy imparted by the electric field stimulation might heat the rings enough to cause fusion of the tips and thus form perfect torii. The present inventors anticipate that even if they are overlapped, one may in a subsequent step thermally fuse the tips to form perfect torii that may be of tremendous theoretical and practical interest. The size of the rings the present inventors produce are controlled by the length of the starting SWNT, and usual concentrations we observe rings of only individual SWNT. The yield in this process appears to be at about 30% of the SWNT observable by AFM.

The SWNT-nanoparticle structures may be used to great advantage in various electronic applications. Therefore the present inventors also contemplate production and utility of liquid suspended nanostructures with useful junction properties, such as:

Semiconducting SWNT with metallic particles that may include, but not be limited to, a class of Schottky diode structures;

Semiconducting SWNT with semiconducting particles that may include, but not be limited to, a class of p-n diode structures; and

Metallic or semiconducting SWNT with insulating particles that may include, but not be limited to, a class of tunnel junction barrier structures.

The present inventors anticipate that these structures may be useful in photoconversion devices either suspended in solution or after deposition on surfaces.

The ring structures also have desirable properties and applications:

SWNT in rings form resonant structures that may be stimulated with either electric fields or magnetic fields; and

SWNT rings closed by insulating particles form resonant structures in a geometry predicted and shown useful for negative index properties.

The present inventors have shown also that the present processes and materials may form rings that are overcoated with metals, e.g. gold layers. The present inventors anticipate that the disclosed processes may be combined, step-wise or simultaneously, to generate metal coated rings closed by insulating rings. By using length-selected SWNT, the present processes and materials allow the ability to generate ring-dot structures with arbitrary and selected diameter, insulating dot size and thickness of metal over-coat. This amounts to a fully controllable R-L-C nanoresonator that may be capable of responding resonantly to selected frequencies within the range spanning RF (MHz) through optical (100 THz) frequencies.

The present processes and materials may provide any one or combination of the following:

Extension to SWNT and any manner of elongated conductive particles;

Extension to semiconducting rods;

Extension to rods suspended in solution;

Extension to include AC electric fields;

Extension to include fields up to optical frequencies in the ultra-violet;

Extension to form rings; and

Extension to form metal oxide particles.

The present inventors anticipate that the present composite nanostructures produced by the present methods may prove to be useful nanoelectronics and catalysts, while the underlying electron transfer and rectifying processes may eventually lead to interesting applications in energy harvesting, nanomedicine and chemical synthesis.

The following examples are included to demonstrate particular embodiments of the present invention. It should be appreciated by those of skill in the art that the methods disclosed in the examples that follow merely represent exemplary embodiments of the present invention. However, those of skill in the art should, in light of the present disclosure, appreciate that many changes may be made in the specific embodiments described and still obtain a like or similar result without departing from the spirit and scope of the present invention.

### EXAMPLES

The present inventors have found compelling evidence for ‘antenna chemistry’ using highly dispersed SWNT-surfactant suspensions and electromagnetic (EM) radiation. Electric field-driven redox processes with reducible transition metal salts result in tip-specific deposition of metallic nanoparticles and sheaths, yielding novel nanoparticle-nanotube structures. The present inventors found substantial evidence that metallic nanotubes participate preferentially in these reactions, which suggests a general route for separating and fractionating metallic nanotube species. Reduction of Fe(III) species to produce nanoparticles on the SWNT tips appears to proceed at or near diffusion-limited rates. These redox processes appear to proceed via a long-range electron transfer mechanism involving tunneling or outright field emission into solution. Reduction of transition metal salts under these conditions to produce nanoparticles further implies strong rectification despite symmetric AC field stimulation.

### Examples 1 to 8

Examples 1 to 8 illustrate formation of nanotube-particulate structures. Examples 1 to 8 further illustrate antenna chemistry of nanotubes.

The present inventors surveyed the response of individualized surfactant-coated SWNT to a broad range of EM sources, including low frequency RF (13.56 MHz), microwaves (2.54 GHz) and broadband light (Near IR to 220 nm UV). Periodic charge accumulation at the SWNT tips is a transient and emphemeral effect, so the present inventors developed an indirect means to detect and visualize charge accumulation and thus potential (voltage) shifts. Here, the present inventors employed fast electron transfer (redox) condensation reactions that generated nanoparticles detectable with AFM (atomic force microscope).

### Example 1

This Example illustrates formation of dumbbells.

To evaluate if optical antennas effects can be seen in SWNT, a mixture of SWNT and metal ion salts (Au and Cu) was exposed to a broad band light source (1367-222 nm). If SWNT behave as an antenna, the accumulation of charge at the end of the tubes will induce the nucleation and deposition of metal preferentially at the tips of the tubes.

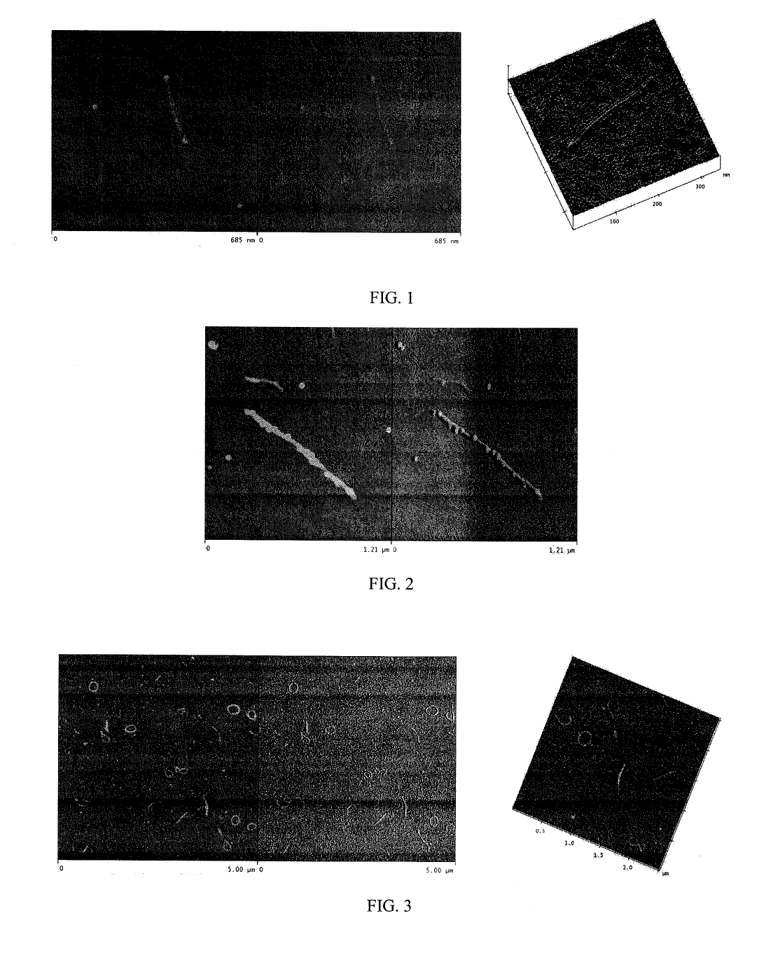

When the mixture of SWNT and metal ions salts was exposed to a light source (1400-200 nm, more specifically 1367-222 nm; 450 Watts), the present inventors observed by AFM a tip selective reduction of Au nanoparticles on the tubes. This suggests that the tubes are behaving as antennas by inducing the reduction of metal nanoparticles at the tips of the tubes (FIG. 1). FIG. 1 shows results when The surfactant was F88 and the metal ion was Au ion. FIG. 1 illustrates that electromagnetic (EM) stimulation (photons, microwave (MW), radiofrequency (RF)) generates tip-selective deposition of metallic nanoparticles, indicating localized antenna chemistry with SWNT. FIG. 1 shows results obtained when the temperature was 25° C. (room temperature). Unless otherwise indicated, other results presented herein were likewise obtained at room temperature.

Essentially identical results were obtained with microwave and radio frequency stimulation using gold and copper salts.

### Comparative Example A

This Example is a comparative example for Example 1 involving thermal activation.

To corroborate the hypothesis, as stated above in Example 1, that the tubes are behaving as antennas by inducing the reduction of metal nanoparticles at the tips of the tubes, a control experiment was run in which reduction of the Au metal salts was induced by heating. The solution of SWNT and metal ion salts were heated to 55° C. in a water bath in the absence of light. AFM images showed that the SWNT sidewalls were decorated with Au nanoparticles without any affinity toward the tips of the tubes (FIG. 2). FIG. 2 shows results when the surfactant was F88 and the metal ion was Au ion. FIG. 2 illustrates that thermal activation generates non-specific deposition of metallic nanoparticles on SWNT.

### Example 2

This Example illustrates formation of rings.

A mixture of SWNT and metal ion salt was exposed to a microwave radiation. High yields of SWNT rings were obtained by simply changing the reaction conditions and specific surfactant mixtures and exposing the SWNT solution to microwaves. The present inventors believe that the accumulation of charges due to microwaves in the tubes allow for the ring formation to occur (FIG. 3). FIG. 3 shows results when the surfactant was a combination of SDBS and PVP (polyvinylpyrrolidone) and the metal ion was Au ion. FIG. 3 illustrates that in mixed surfactant suspensions, SWNT form neat rings about 100 nm in diameter when stimulated with microwaves.

### Example 3

This Example illustrates formation of split-rings.

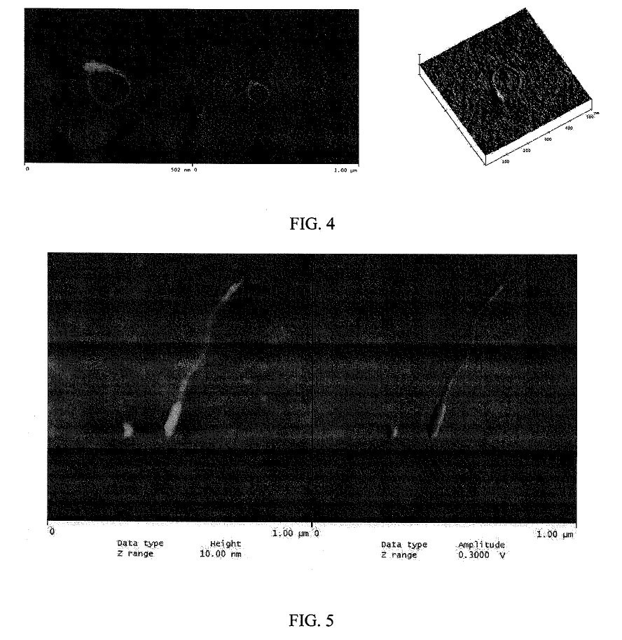

A mixture of SWNT and metal ion salt (Cu) was exposed to microwave radiation. The present inventors found that the procedures of redox reaction and microwave stimilation can be combined and performed simultaneously to generate split-ring structures in one step. The yields of such structures amounted to almost half of the nanotubes observed by AFM in these samples (FIG. 4). FIG. 4 shows results when the surfactant mixture was a combination of SDBS and PVP and the metal ion was Cu ion. FIG. 4 illustrates processes generating rings and tip-selective nanoparticle deposition can be combined to generate novel split-ring structures.

### Example 4

This Example illustrates formation of nanotubes partially encapsulated with metal.

A mixture of SWNT and metal ion salt (Au) was exposed to a broad band light source (1367-222 nm). FIG. 5 shows results when the surfactant was SDS. FIG. 5 illustrates a partially encapsulated SWNT.

### Comparative Example B

Example B is a comparative example for Example 4 involving thermal activation.

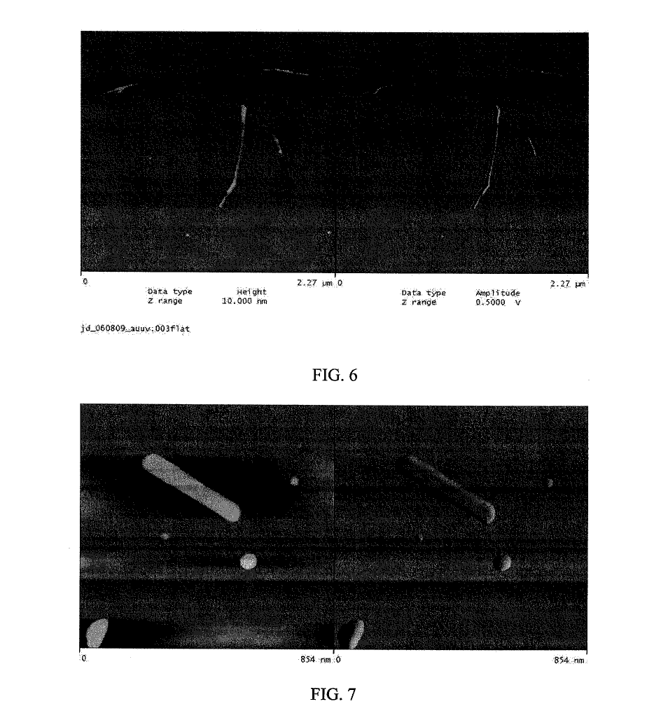

A mixture of SWNT and metal ion salt (Au) was heated to 55° C. in a water bath in the absence of light. FIG. 6 shows results when the surfactant was SDS.

### Example 5

This Example illustrates formation of nanotubes covered with metal.

A mixture of SWNT and metal ion salt (Au) was exposed to microwave radiation. FIG. 7 shows results when the surfactant was SDS. FIG. 7 illustrates a SWNT covered with metal.

### Example 6

This Example illustrates formation of dumbbells.

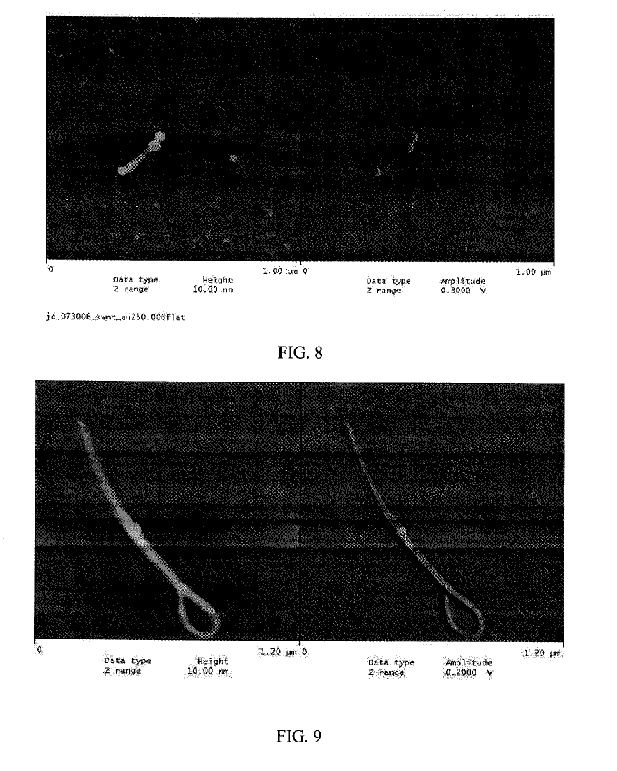

A mixture of SWNT and metal ion salt (Au) was exposed to a broad band light source (1367-222 nm). FIG. 8 shows results when the surfactant was SDBS. FIG. 8 illustrates a dumbbell formation. In FIG. 8 there SWNT is also decorated with an extra nanoparticle located towards an end.

### Comparative Example C

Example C is a comparative example for Example 6 involving thermal activation.

A mixture of SWNT and metal ion salt (Au) was heated to 55° C. in a water bath in the absence of light. FIG. 9 shows results when the surfactant was SDBS.

### Example 7

This Example illustrates formation of rings of various metal coverage.

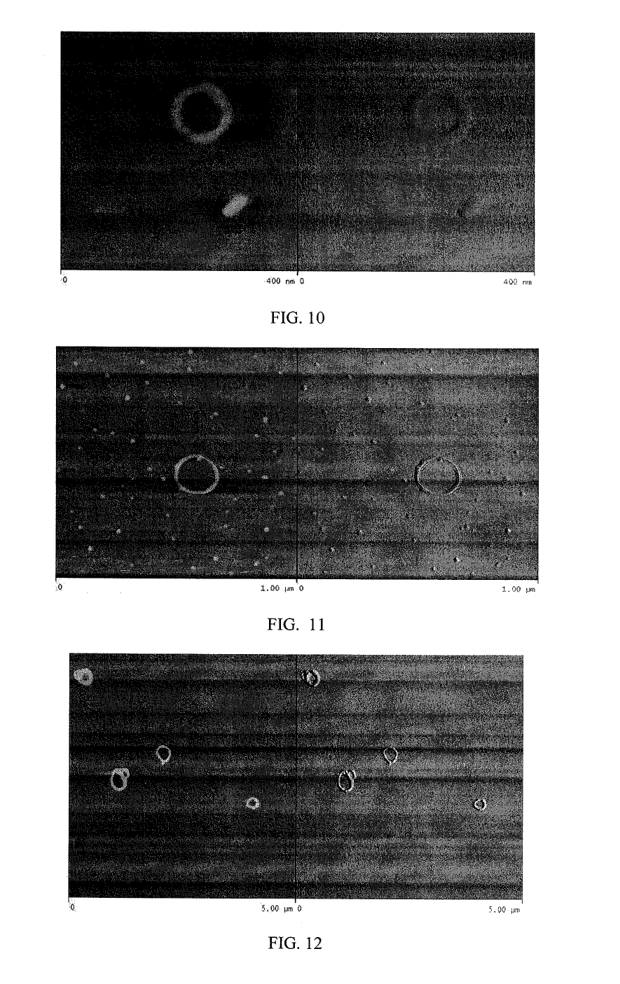

Mixtures of SWNT and metal ion salt (Au) were exposed to microwave radiation. FIGS. 10-12 show results when the surfactant was SDBS. FIG. 10 shows rings with no metal. FIG. 11 shows rings adorned with metal. FIG. 12 shows rings covered with metal. FIG. 12 was obtained under conditions of higher metal ion concentration than the conditions associated with FIG. 11, which was obtained under conditions of higher metal ion concentration than the conditions associated with FIG. 10.

### Example 8

This Example illustrates formation of rings on sticks.

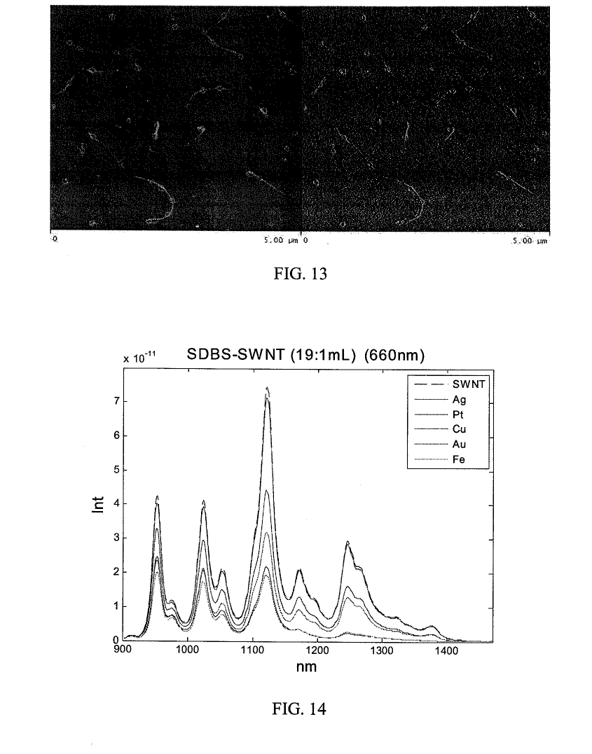

A mixtures of SWNT and metal ion salt (Au) was exposed to microwave radiation. FIG. 13 shows a result when the surfactant was a mixture SDBS and PVP. FIG. 13 illustrates rings on sticks.

### Example 9

This Example illustrates electron transfer of nanotubes and various metal ions.

The present inventors used salts of various transition metals (e.g. Pt, Pd, Ag, Au, Cu, Fe) spanning a range of redox potentials to probe the voltages generated at SWNT extrema under EM excitation. Table 1 lists redox potentials of metal ion salts used to generate the results shown in FIG. 14.

TABLE 1

| | Redox |
|---|---|
| | Potential |
| Metal Ion Salt | (Volts) |
| AgSO₄ | 0.654 |
| H₂PtCl₆ | 0.68 |
| Cu(II)Cl (CuCl₂) | 0.3452 |
| HAu(III)Cl (HAuCl₂) | 1.002 |
| Fe(III)Cl (FeCl₃) | 0.771 |

19 mL of SDBS-SWNT solution at 5 mg/L was mixed with 1 mL of metal ion solution at 1 mM. The EM excitation was provided by microwave radiation. FIG. 14 shows 660 nm fluorescence spectra. These results reflect electronic transfer between SWNTs and the various metal ions in the salts listed in Table 1 (a Ag ion, a Pt ion, a Cu ion, a Au ion, and a Fe ion). 785 nm fluorescence spectra (described with a figure in the priority application which is incorporated by reference) also reflect electronic transfer between SWNTs and the metal ions listed in Table 1.

### Example 10

This Example illustrates formation of reactive oxygen species (ROS). Further, This Example illustrates evidence of field emission of charge carriers from the nanorod tips directly into solution. Still further, the present inventors believe this Example to indicate generation of solvated electrons.

The present inventors detected the effects (not the oxidizing species themselves) using fluorescein-based dyes that were developed specifically for detecting ROS in biological systems. The present inventors detected oxidizing species via ROS using surfactant suspended SWNT in aqueous solution when stimulated with microwave radiation (2.54 GHz at 1000 Watts) for ten seconds (in a microwave oven). The peak electric field generated by such a microwave source is roughly 0.5 volt per micron.

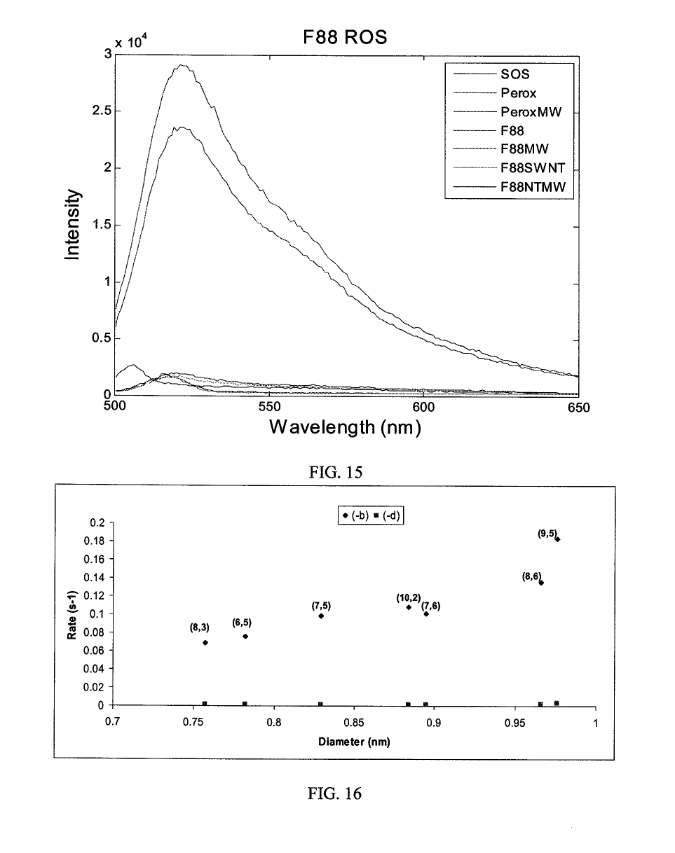

10 μL of 3.45×10⁻⁷ mol/mL reactive oxygen species (SOR) was added to 1 mL solution with and without SWNT. SWNT solutions had a concentration of 10 mg/L. Florolog was used with the parameters: 440 nm excitation, 455 nm filter, 500-650 nm scan. FIG. 15 shows results without surfactant. FIG. 16 shows results for F88 surfactant. FIG. 15 indicate formation of ROS. Results for CTAB and TritonX and without surfactant (described with figures in the priority application which is incorporated by reference) similarly indicate formation of ROS.

### Example 11

This Example illustrates redox preferentially toward large diameter tubes during electron transfer of SWNT and metal ions. Further, this Example illustrates faster rates for large diameter tubes.

The objective of the experiments described was to examine the effects of metal ions to specific tubes. In this Example, the tube were semiconducting tubes. The present inventors note that similar results may be achieved for metallic tubes. Further, the present inventors note that the faster rates for larger diameter tubes illustrated in this Example provide a basis for fractionation by diameter.

The procedure involved: taking an initial spectrum; finding the max of each peak; exposing SWNT to metal ions; monitoring the fluorescence as a function of time; obtaining the relative intensity of each peak for every spectrum; plotting it as a function of time; finding the rate of decay; plotting the rates of decay as a function of tube diameter.

30 μL of 1 mM Fe(III) were added to 1 mL (5 mg/L) SDBS-SWNT. A 660 nm laser was used. The spectrum was taken every second.

FIG. 16 shows results for the rate of decay as a function of tube diameter. FIG. 16 illustrates faster rates of decay with larger tube diameters.

### Example 12

This example illustrates the antenna properties of nanotubes.

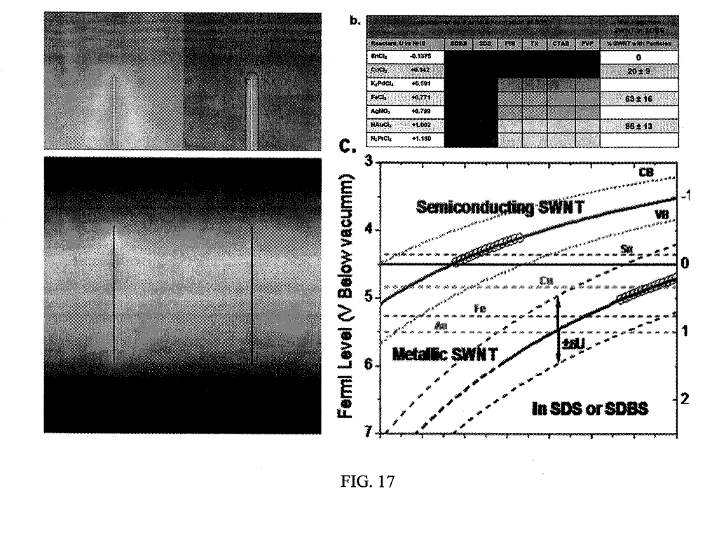

FIG. 17.a sshows the results of a model calculation of the electric field structure around an individual metallic nanotube with length L=1 μm and diameter D=1 nm aligned with an electric field of magnitude E=1 V/μm. By redistribution of charge carriers, the metallic nanotubes polarize to maintain uniform potential. In AC fields, an induced potential of δU=±EL/2≈±0.5 V is generated between the SWNT tips and the electrolyte bath nearby, effectively modulating their normal redox potential. In this example, the applied field strength will be amplified at the tip by approximately β/2 (β≡L/D), where β˜1000, to give a local effective field strength of Eₜᵢₚ≈500 V/μm. Assuming a hemispherical SWNT tip, the local field gradient will decrease rapidly with r⁻², strongly affecting only a few tens of nm around the SWNT tip. The cylindrical region alongside the SWNT, but close to the tip, will experience a much more modest r⁻¹ gradient. From this simple model, the present inventors thus reasonably expect that any antenna effects will be most apparent at the tips of metallic nanotubes, with redox reactions driven by potential modulation, field emission or tunneling.

### Comparative Example D

### Thermal Activation

This Example is a generalize comparative Example.

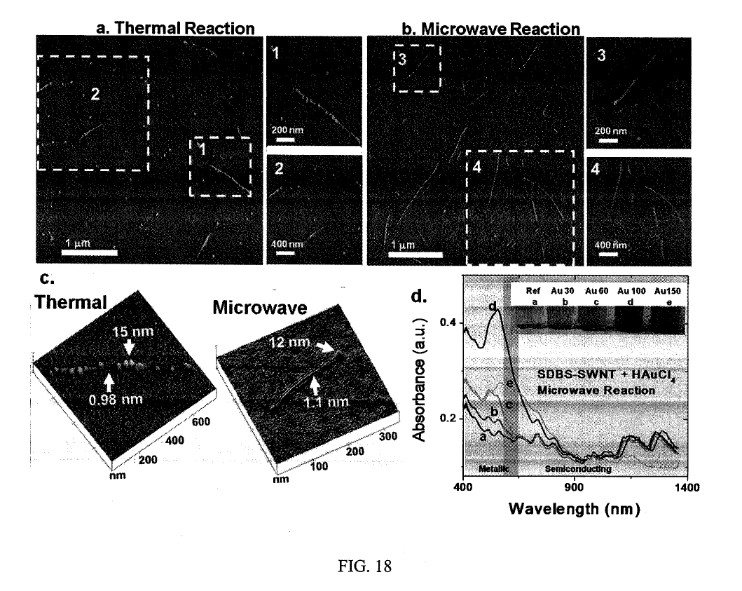

The present inventors performed a matrix of control experiments to screen out spontaneous redox reaction between a panel of transition metal species and several common SWNT-surfactant suspensions. 1 mL surfactant-SWNT samples (1 wt % surfactant, 7 mg/l SWNT) and 30 μL metal salt solution (1 mM), were warmed to 55° C. for 2 hours, then characterized with UV-Visible absorbance, Near IR fluorescence and atomic force microscopy (AFM); no specific reducing agents, were employed. The general results are tabulated and color coded in FIG. 17.b. No spontaneous reactions were observed in sodium dodecylbenzene sulfonate (SDBS) suspensions, while the related anionic surfactant, sodium dodecyl sulfonate (SDS), supported only very slow reactions (taking over 48 hrs) with H₂PtCl₆ or HAuCl₄. Neutral (Triton-X (TX) and Pluronics (F88)) and cationic (cetyltrimethylammonium bromide (CTAB)) surfactants supported rapid spontaneous reactions with most metal salts tested. FIG. 18.a, an AFM image of a representative spontaneous reaction product, HAuCl₄ with SWNT suspended in Pluronics F88, clearly shows a combination of free metal particles and non-selective sidewall decoration of the SWNTs. This reaction mixture turned reddish within ten minutes, and developed a strong UV-Vis absorption peak at 523 nm; both factors are indicative of gold nanoparticle formation. The present inventors further verified that no gold detectable (by UV-Vis or AFM) nanoparticles were produced when SDBS solutions (without SWNT) were heated with HAuCl₄, either on a water bath or in a multi-mode microwave reactor (MARS_{X}, CEM, 2.54 GHz) at 1000 W for 10 s.

### Example 13

This Example illustrates formation of nanotube-particulate structures. This Example further illustrates antenna chemistry of nanotubes.

Remarkably, when SDBS-SWNT suspensions were irradiated in the microwave reactor for 10 s at 1000 W (standard MW protocol—see Example 17) in the presence of gold chloride, the solutions immediately displayed characteristic color changes and UV-Vis absorbance, indicating Au nanoparticle formation (FIG. 18.d). AFM images of SWNTs treated in this manner show a preferential deposition of Au nanoparticles at the tips of the SWNTs (FIG. 18.b.3). The reaction was complete in 10 s or less, and the reaction mixture heated by 36.2 (±1)° C. during the procedure. A control solution of 1% SDBS in DI water (without SWNTs) heated by 35.7 (±1)° C. This negligible difference eliminates the possibility of significant localized thermal effects via direct MW heating of these well dispersed SWNT. Particle formation in this case is plainly driven by the microwave treatment, and not by a simple thermal process. At higher initial gold concentrations (150 μM Au), the present inventors also found progressive growth of an apparent coaxial metal sheath extending back from the tips of some of the SWNTs (FIG. 18.b.4). These sheaths have a fairly constant height of 10 nm, while the tip particles averaged 14 nm in height by AFM. This deposition structure mimics the locus of high field gradients around the SWNT, and the purplish color of the solution and its extended UV-Vis absorption feature is consistent with the known spectroscopic characterisitics of gold nanorods (FIG. 18.d.e). Close examination of the AFM images also shows that while a substantial fraction of the SWNTs have attached metal particles, others are devoid of particles. This is true even of short nanotubes (˜500 nm), which should diffusionally rotate in three dimensions on the time scale of the experiment (thus ensuring at least occasional alignment with and activation by the MW electric field), which suggests that the reaction may be preferential towards particular SWNT types.

### Example 14

This Example illustrates SWNT type selectivity.

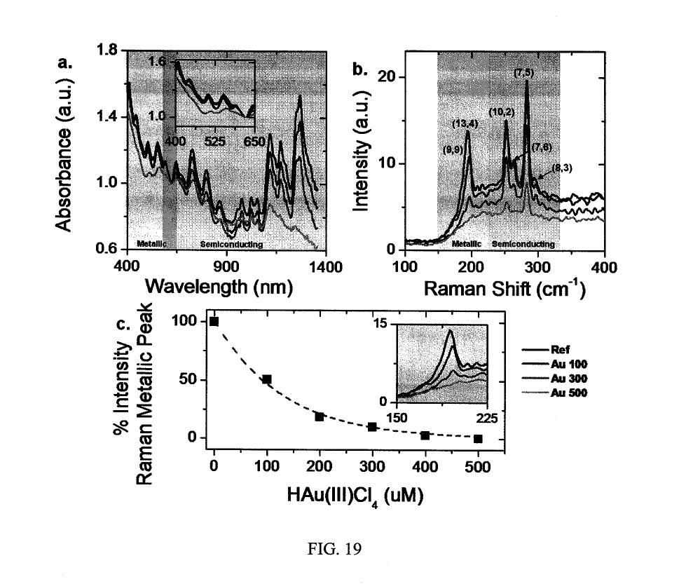

To probe SWNT type selectivity in these reactions, the present inventors analyzed the UV-Vis and solution phase Raman signatures of SDBS-SWNT-HAuCl₄ mixtures after microwave processing and mild centrifugation (MicroD, Fisher Scientific) at 4,500 G for 10 minutes to remove larger Au particle-containing species from solution. Spectra for the reference sample (without gold) were unaffected by microwave treatment and centrifugation (FIG. 19.a-b, in black). FIG. 19.a-b shows the effect of adding 3 different volumes of 1 mM HAuCl₄ solution to the SWNT suspension prior to microwave processing. A significant and progressive depletion of the metallic peaks (400-650 nm) (inset, FIG. 19.a) is seen with increasing Au salt concentration, along with eventual bleaching of the E₁₁ transitions for the large diameter semiconductors (1100-1400 nm). Further evidence of type selectivity in this process is provided by Raman spectra obtained using 633 nm excitation, which samples a portion of both metallic and semiconducting SWNT populations. Solution-phase Raman avoids morphology-related modifications associated with precipitated SWNT, and allows quantitative interpretation by integrating the area of radial breathing mode (RBM) peaks for metallic (˜150-220 cm⁻¹) and semiconducting (˜230-300 cm⁻¹) SWNT populations. FIG. 19.c shows that the metallic fraction after centrifugation decreases faster than semiconducting SWNTs (FIG. 19.b), approximately exponentially with increasing gold concentration (red dotted line, FIG. 19.c). When the SWNT suspension is MW processed with 500 μL of gold solution, essentially all of the metallic SWNT species are removed after centrifugation (FIG. 19.c inset), yielding a supernatant apparently highly enriched in semiconducting SWNTs. Concurrent removal of some of the semiconducting SWNT via bundling with metallic SWNT could account for their decreased concentration in the final supernatant. Metallic SWNT separation Raman analysis is further described in Example 20.

### Example 15

This Example illustrates diffusion-limited formation of nanotube-particulate structures.

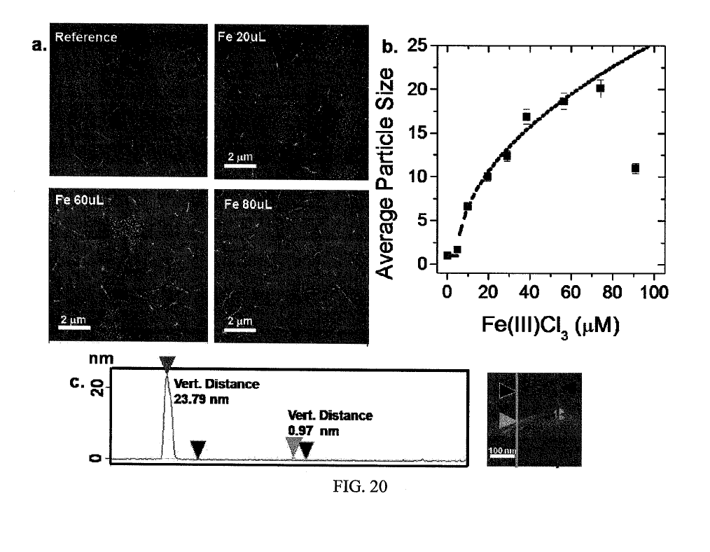

Electrodeposition reaction kinetics were examined in the MW-driven reaction between SWNT suspension and FeCl₃ (0.774 V vs. NHE), which generates relatively few free-floating particles. FIG. 20.a shows AFM images of individual SWNTs with metal particle formation with four different metal ion concentrations. As with gold, particles were predominantly deposited at the ends of the SWNTs. FIG. 20.c shows a representative AFM image of an individual SWNT with attached nanoparticles at its tips, and their respective vertical heights. FIG. 20.b reveals that the size of the metal particles (95% confidence intervals) increases sub-linearly with iron concentrations up to 80 μM. Initial Fe(III) concentrations above 80 μM results in spontaneous sedimentation of SWNT-metal complexes after MW treatment, which probably accounts for the decrease in observed particle size with the highest iron concentrations. No nanoparticles were detected with starting iron concentrations below 5 μM, which could be attributed to SDBS sequestration of Fe(III) cations at sites inaccessible to reduction by SWNT tips (at SWNT sidewalls or on free SDBS micelles). The present inventors employed Eq. 1 to describe the kinetics of spherical diffusion limited electrodeposition on ultramicro electrodes; for sub-micron diameter electrodes the time dependant term can be neglected. Rearranging this expression to give the particle size as a function of feedstock concentration (Eq. 2), we obtained a near-quantitative match to the experimental data at t=1 s using the molar volume Vₘ for Fe⁰ and literature values for the diffusion rate D of Fe(III) (see Example 21 for details).

$$\begin{matrix}I = ( \frac{{zFD}^{\frac{1}{2}} c}{{π}^{\frac{1}{2}} {t}^{\frac{1}{2}}} ) + ( \frac{zFDc}{{r}_{o}} ) & ( 1 ) \\ {r}^{2} = 0.75 {V}_{m} Dct & ( 2 )\end{matrix}$$

This satisfying agreement between experiment and established kinetic theory (red curve) for electrodeposition at ultramicroelectrodes strongly suggests that formation of iron nanoparticles proceeds at diffusion limited rates. The process could be complete within one second, with deposition rates corresponding to currents on the order of 10⁻¹⁵ A per SWNT tip (see Example 21).

### Example 16

This Example describes calculations to further elucidate electron transfer between nanotubes and various metal ions. Further, this Example illustrates the provision of a system for copious field emission into solution. In this Example the system includes nanotubes, surfactant, metal ions, and microwave radiation.

The fundamental mechanism involved in this facile antenna chemistry is an important question to consider. Reactant cations (e.g. Fe(OH)₂⁺) may associate with the surfactants' sulfonate anions before reduction, while anionic reactants (e.g. AuCl₃⁻) cannot be expected reside any closer to the nanotube surface than the surfactants' outer Helmholtz plane. Nanoparticle formation therefore likely involves a long-range electron transfer of at least 3-4 nm. Comparing results and reactant potentials summarized in table in FIG. 17.b with the oxidation potentials for metallic SWNT of various diameters in FIG. 17.c (see Examples 18 and 19 for analysis related to the application of FIG. 17.c for SDBS and/or SDS), there is clearly a correlation between reactivity and the fraction of SWNT with potentials lower that the reactants. And yet nanoparticle formation is neither spontaneous nor thermally activated in any case; the process is certainly activated by the microwave field.

The present inventors estimate the average electric field strength in the MW reactor to be ˜3.45×10⁵ V/m when operating at 1000 W (see Example 23 for details). This would modulate the potential at the tip of an average length metallic SWNT (L=300 nm) by roughly ±51 mV. Since many metallic SWNT normally reside at potentials more negative than HAuCl₄ (1.003 V) or FeCl3 (0.774 V), this small ‘dynamic overpotential’ would seem an insufficient driving force alone for this robust reaction. The present inventors also examined the amount of electrodeposition current that could be expected from a field emission process using the Fowler-Nordheim equation. Using the classic geometric enhancement factor 13 and a barrier height corresponding to the oxidation potential of the SWNT (˜1.5 V) indicates that only long tubes, those approaching 5 μm, could generate the 10⁻¹⁵ Amps per tip needed to generate observable nanoparticles within 10 s. 500 nm tubes would require unrealistically low barriers of 0.25-0.30 V to generate sufficient current. However, when the present inventors quantitatively considered the potential gradient ‘compression’ caused by the thin, low-K dielectric shell of SDBS alkyl groups, as visualized FIG. 17.a, the present inventors found that the effective electric field was enhanced by an additional factor Z* of 10-25 over the geometric β, depending on the diameter of the nanotube. Z* for 1 nm diameter SWNT is ˜16; this increases the expected emission current for 500 nm long tubes to 10⁻¹⁵ A with ˜1.7 V barrier, which is close to its oxidation potential. Longer tubes, or those with lower potential barriers, could emit substantially more current. Higher currents may eventually be limited by SWNT charging, recombination and space charge effects, but may account for the free-floating nanoparticles observed in this system. The present inventors consider the various experimental results described herein in the Examples to be consistent with a field emission mechanism augmented by field ‘compression’ in the surfactant layer.

### Example 17

This Examples illustrates a standard MW Protocol. This Example is referenced in Example 13.

SWNT-microwave interactions were surveyed using aqueous surfactant suspensions of individualized raw HiPco SWNT (batch number 164.4). The surfactant suspensions were prepared using homogenization, ultrasonication and ultracentrifugation following standard literature methods known to one of ordinary skill in the art. Deionized (DI) water at 18 MΩ resistivity obtained from a NanoPure (Barnstead, Dubuque, Iowa USA) system was used throughout this work. Surfactants employed included Pluronics (F88-Prill, BASF), sodium dodecyl sulphate (SDS, 99+%, Aldrich), dodecylbenzenesulfonic acid, sodium salt (SDBS, 99+%, Aldrich), Triton-X (TX-100, 99%, Aldrich), and cetyl-trimethyl-ammonium bromide (CTAB, 99%, Aldrich); all were used as received and employed at 1 weight percent (wt %) in DI water. The SWNT concentration in suspensions were adjusted to 10 mg/L; SWNT concentrations were determined by absorbance following standard literature methods known to one of ordinary skill in the art. Transition metal salts, all used as received from Aldrich, were used as redox agents, including gold (HAuCl₄, 99.999%), silver (AgNO₃, 99.999%), palladium (K₂PdCl₄, 99.99%), platinum (H₂PtCl₆, 99.995%), copper (CuCl₂, 99.999%), tin (SnCl₂, 99.99%) and iron (FeCl₃, 99.99%). All metal salt solutions were prepared at a concentration of 1 mM in DI water. Unless otherwise stated, all MW reactions were performed in a MARS_{X} (CEM Corporation, NC) operating at 2.54 GHz (multimode) with 1000 W for 10 s. MW reactions were performed with 1 ml of SWNT suspension (plus variable amounts of metal salt solution, as noted) in 2 mL glass vials (1 cm diameter.×3 cm tall). The (uncapped) sample vials were placed within 2 mm of the geometric center of the bottom panel of the MW reactor; no other accessories were placed inside the reactor.

Unless otherwise stated, all spectroscopic measurements were obtained with 1 ml of a given SWNT-surfactant mixture in a sterile 1.5 mL polymethylmethacrylate (PMMA) cuvette (LPS, L324101). UV-visible-NIR absorbance and fluorescence spectra were obtained with a Nanospectralyzer Model NS1, Version 1.95 (Applied Nanofluorescence, Houston, Tex., USA). Absorbance spectra were obtained in the visible and near infrared regions (400 to 1400 nm) using integration times of 500 ms and 10 accumulations. The SWNT fluorescence was excited at 660 nm and emission spectra were obtained between 900 and 1400 nm using 500 ms integration times and 10 accumulations. Absorbance at 763 nm was used to normalize the fluorescence spectra. Liquid-phase Raman measurements were obtained using 633 nm laser excitation in an in Via micro-Raman spectrometer (Renishaw, Gloucestershire, UK). Liquid samples were held in a Renishaw Raman Macro Sampling Set. Raman spectra were collected from 100 to 3200 cm⁻¹ with Wire2 data acquisition software, and using 20 s exposure times and 1 accumulation.

Atomic Force Microscope (AFM) images were obtained with a Nanoscope IIIa (Digital Instruments/Veeco Metrology, Inc., Santa Barbara, Calif. USA), operating in tapping mode, using 1-10 Ohm-cm phosphorus (n) doped Si tips (Veeco, MPP-11100-140) at a scan rate of 2 Hz and 512×512 resolution. Samples for AFM analysis were prepared with 20 μL of SWNT suspensions spin coated at 3000 RPM onto a roughly 0.25 cm² freshly cleaved mica surfaces (Ted Pella, Inc., Redding, Calif. USA), and rinsed with DI water. Samples were left spinning for 10 min to dry thoroughly.

### Comparative Example E

This Example is a comparative Example which describes spontaneous nanoparticle diameter statistics and involves thermal activation.

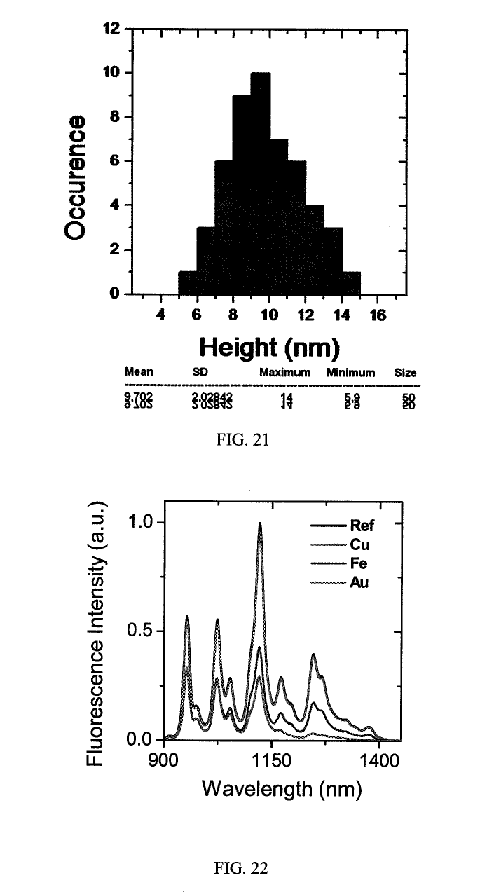

Nanoparticles were spontaneously produced in a mixture of 1 mL F88-SWNTs and 30 μL HAuCl₄ (1 mM) upon heating to 55° C. for 2 hrs. UV-Vis spectra and TEM images (not shown) confirm the presence of gold nanoparticles. The heights of 50 such Au nanoparticles were measured by AFM, and histogammed as shown in FIG. 21. The sample showed an average height of 9.7 nm with a standard deviation of 2 nm. Similar particles distribution was observed with other metal salts and the average particle size increased with higher metal concentration.

### Example 18

This Example illustrates a SWNT redox potential model. This Example is referenced in Example 16.

FIG. 17.c depicts our current understanding of the redox landscape for aqueous suspensions of SWNTs in small-molecule anionic surfactants, including SDS and SDBS. The lines for the semiconductor mid-gap and metallic Fermi level are derived from spectroelectrochemical data reported by Okazaki, et al. (K. Okazaki, Y. Nakato, K. Murakoshi, Physical Review B 68, 35434 (Jul. 15, 2003)) and plotted in the manner similar to O'Connell, et al. (M. J. O'Connell, E. E. Eibergen, S. K. Doom, Nature Materials 4, 412 (May, 2005)), who verified the semiconductor valence band levels using organic oxidizers to quench fluorescence in the near IR. Okazaki monitored the intensity of Raman radial breathing mode (RBM) scattering from individual laser-oven SWNT (ca. 2 nm dia.) captured on a gold electrode as a function of electrode potential versus an electrolyte containing sodium dodecylbenzene sulfonate (SDS). The potentials giving maximum RMB intensity for given individual SWNT were reported as the absolute Fermi level for metals and the absolute mid-gap level for semiconductors. Metals and semiconductors were found to follow distinct linear trends when plotted against RBM frequency, respectively, with V_{f(met)}=1.120+22.2 mV*v_{rbm} and V_{f(semi)}=1.584+12.0 mV*v_{rbm} (V in volts below vacuum; v_{rbm} in cm⁻¹; V_{f(semi)} Since RBM frequencies are uniquely related to tube diameter by v_{rbm}=A/dₜ+B (with A=223.5 cm⁻¹ and B=12.5 cm⁻¹), and the bandgap florescence wavelength of semiconducting SWNT varies to first order inversely with diameter with λ₁₁=1167dₜ (both in nm), we can generate a simple quasi-linear relationship for the Fermi level and redox potentials of semiconducting and metallic SWNT as a function of diameter (for metals) and bandgap emission frequency (for semiconductors) together. Normal Hydrogen Electrode (NHE) (V_{NHE}=0) is known to usually taken to be 4.5 volts below the vacuum level, allowing one to relate redox potentials to the work function, which is referenced to vacuum.

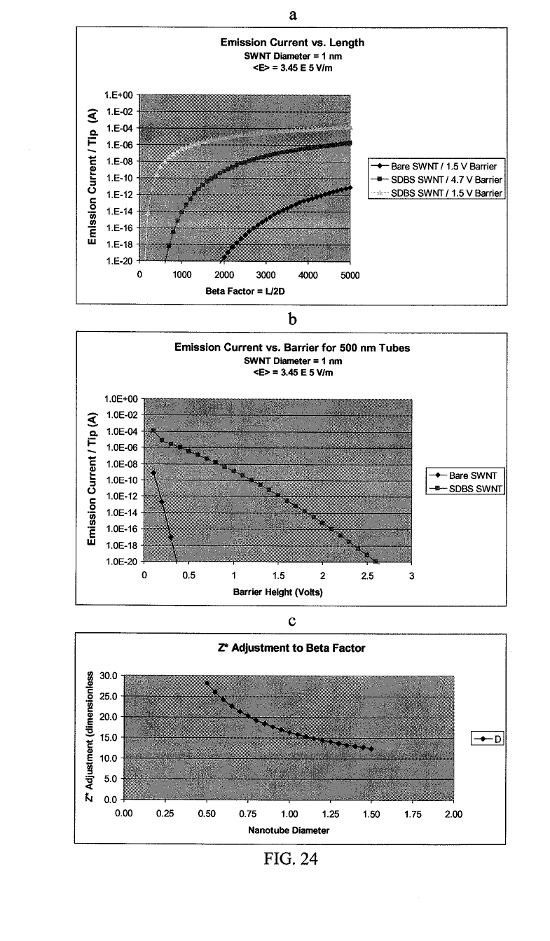

Both of these prior works referenced above examined SWNT in conjunction with aqueous SDS. The redox potentials of SWNT in our SDBS suspensions appear to be equivalent to those in SDS, since, since the pattern and degree of diameter-selective fluorescence quenching by FeCl₃ (0.774 V vs. NHE) is similar (see FIG. 24.) to that caused by 4-amino-1,1-azobenzene-3,4-disulphonic acid (AB) (˜0.65 V vs. NHE) as reported by O'Connell et al. The present inventors caution that the metallic curve in particular is an extrapolation from a fairly small set of tubes (with diameters of) observed by Murakoshi, so the Fermi levels for smaller tubes like those in our samples (0.8-1.4 nm; 1.1 nm average) are desirably be taken as an approximation. The present inventors further caution that the redox levels shown might not be valid for nanotubes suspended in neutral or cationic surfactants.

The colored band straddling the locus of metallic SWNT redox potentials shows the expected range that these metallic species should display if the SWNT are 1 micron long and stimulated with AC electric fields of 1 V/μm.

### Example 19

This Example illustrates near infrared fluorescence of SDBS-SWNT with transition metal salts. This Example is referenced in Example 16.

FIG. 22 shows the NIR fluorescence spectrum with 660 nm excitation wavelength of 1 mL SDBS-SWNT solution (10 mg/L) after the addition of 60 μL of 1 mM metal ions (Cu, orange; Fe, magenta; Au, green and reference solution, black). NIR fluorescence quenching for semiconducting SWNT clearly depends on the oxidation potential of the metal salt added, and systematically depends on SWNT diameter. The driving force for oxidative electron transfer increases with tube diameter, so the larger SWNT species are more thoroughly quenched. This result is consistent with the work of Okazaki et al. and O'Connell et al. described above in Example 18. We conclude that the redox model based on these works which employed SDS SWNT suspensions are valid for the present work which employs SDBS SWNT suspensions.

### Example 20

This Example illustrates metallic SWNT separation Raman analysis. This Example is referenced in Example 14.

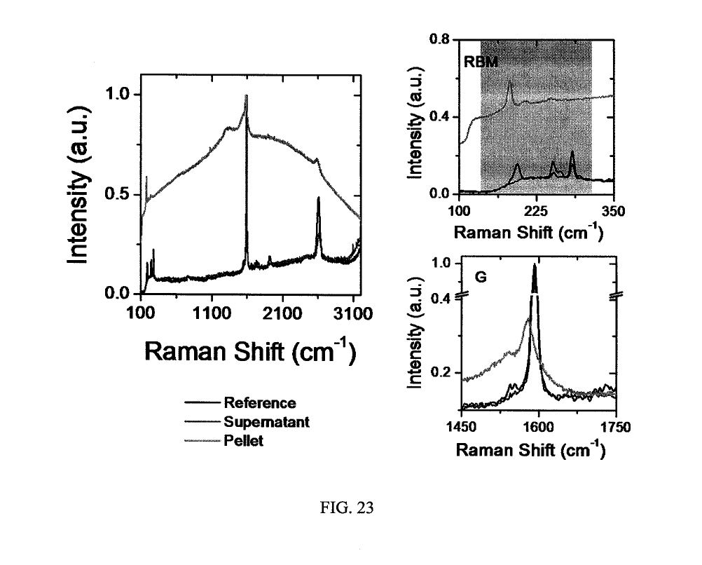

After microwave processing and mild centrifugation (as discussed in Example 14) of both the reference and the solution with 500 μL Au, we obtained liquid-phase Raman (633 nm) of the reference solution (black), and the supernatant (red) and the pellet (orange) of the solution with 500 μL Au and the spectra was normalized to their respective G peaks. The pellet was resuspended in 100 uL of DI water in order to obtain liquid-phase Raman. The reference SWNT suspension displayed no color change after microwave treatment, nor was a pellet formed during centrifugation. FIG. 23 shows that SWNTs are present in both the supernatant and pellet, since the main spectroscopic characteristics of SWNTs (RBM and G peaks) are present in both. The supernatant solution is enriched in small diameter semiconducting SWNT as previously explained, while the pellet exhibits an enrichment of metallic tubes. The Raman spectrum of the pellet has a significantly higher baseline, which might be attributable to lossy scattering from the many gold nanoparticles therein. Notably, the G peak in the pellet displays a −12 cm⁻¹ shift, while the D band feature is increased compared to the reference spectrum. We attribute the D feature to gold nanoparticle attachment. The G peak shift may be indicative of charge injection from the gold nanoparticles. Furthermore, the phonon peak attributed to metallic SWNTs (1550 cm⁻¹) disappears for the enriched semiconductive supernatant solution and reapers for the resuspended pellet (enriched in metallic SWNTs) as comparison to the reference solution.

### Example 21

This Example illustrates electrodeposition kinetics. This Example is referenced in Example 15.

The kinetics and modeling of electrodeposition on ultramicro electrodes has been thoroughly reviewed by Hyde and Compton (M. E. Hyde, R. G. Compton, Journal of Electroanalytical Chemistry 549, 1 (Jun. 5, 2003)) and applied by Milchev, et al. (A. Milchev, D. Stoychev, V. Lazarov, A. Papoutsis, G. Kokkinidis, Journal of Crystal Growth 226, 138 (June, 2001)) who demonstrated that Equation 3 accurately describes the deposition current density under spherical diffusion limited conditions, and that for micron-scale (or smaller) electrodes, the time dependant term can be neglected. From this, the present inventors derive an expression relating the deposited particle size as a function of initial feedstock concentration and time (Equation 8), as follows:

$$I = ( \frac{{zFD}^{\frac{1}{2}} c}{{π}^{\frac{1}{2}} {t}^{\frac{1}{2}}} ) + ( \frac{zFDc}{{r}_{o}} ) \qquad ( 3 )$$

Neglecting the time dependent term, gives

$$I = ( \frac{zFDc}{{r}_{o}} ) \qquad ( 4 )$$

Expanding the current density term, and substituting in the cross-sectional area (πr²) of electrode (the growing metallic nanoparticle) yields

$$\frac{q}{t} = {zFDcr}_{o} π \qquad ( 5 )$$

After expressing the amount of deposited material in moles (M=q/zF), the present inventors have

$$\frac{M}{t} = {Dcr}_{o} π \qquad ( 6 )$$

Assuming a spherical deposit of volume v=4/3πr³, and expressing same via its molar volume (Vₘ), the present inventors rearrange to

(4/3)πrₒ³=VₘDcrₒπt (7)

The present inventors rearrange this to relate r to time, and at t=1 s, the present inventors obtain

r²=(4/3)VₘDc (8)

Using an experimentally determined literature value of 3×10⁻⁶ cm²s⁻¹ for the diffusion rate of Fe(III) in water and 7.09 cm³/mole for the molar volume of Fe⁰ resulted in a near-quantitative match to the observed experimental data, as described in the main text. We note that if the iron nanoparticles are oxidized (which increases their molar volume, iron basis) then the deposition rate could be as much as a factor of two lower (the molar volumes of FeO, Fe₃O₄ and Fe₂O₃ are 11.97, 14.92 and 15.20 cm2/mole, respectively).

TABLE 2

| Parameter | Variable | Value | Units |
|---|---|---|---|
| Valence | z | 3 | |
| Faraday's constant | F | 96,500 | [C/mol] |
| Diffusion coefficient | D | 3 × 10⁻⁶ | [cm²/s] |
| Molar volume | Vₘ | 7-15 | [cm³/mol] |
| Concentration | c | | [mol/cm³] |
| Current density | I | | [A/cm²] |
| Current | i | | [A] |
| Time | t | | [s] |
| Radius | r | | [cm] |
| Charge | q | | [C] |
| Moles | M | | [mol] |

### Example 22

This Example illustrates SWNT field emission modeling. This Example is referenced in Example 16.

The present inventors first estimate the effective electric field strength in the microwave reactor using two approaches. The first is based on energy conservation in conjunction with the Poynting vector. Since the SWNT samples are so small (1 ml), the present inventors assume that the MW energy coming into the reactor from the magnetron is dissipated uniformly over the interior surface of the working chamber. Given a 1 kW input power and 2.1 m² interior surface area, the local power density is ˜476 W/m². Using this value in conjunction with the Poynting vector (Eq. 9), which relates power flow across a surface to the average electric field strength (Eq. 10), we compute the (free space) electric field strength (Eq. 11) to be ˜3.5×10⁵ V/m.

$$S = E \times H = \frac{1}{{μ}_{0} {μ}_{r}} E \times B \qquad ( 9 )$$

Solving for the time average magnitude of the Poynting vector in terms of E

$$〈 S 〉 = \frac{{ɛ}_{o}^{2} c}{2} \sqrt{\frac{{ɛ}_{r}}{{μ}_{r}} {E}^{2}} \qquad ( 10 )$$

And isolating E, the present inventors obtain

$$E = \frac{1}{{ɛ}_{o}} \sqrt{\frac{2 * 〈 s 〉}{c \sqrt{\frac{{ɛ}_{r}}{{μ}_{r}}}}} \qquad ( 11 )$$

A second approach for estimating the electric field strength in the reactor is based on observed solution heating rates in conjunction with established dielectric heating theory (Eq. 12) and physical constants for water.

$$Δ T = \frac{2 π tf {ɛ}_{o} {ɛ}_{r}^{′} tan δ {V}^{2}}{{C}_{p} ρ} \qquad ( 12 )$$

1.0 ml samples of DI water, processed under the standard MW protocol, heated by 25.0° C. Using f=2.45 GHz, and 12 for the loss factor (∈ᵣ′ tan δ) and 4.18 J g⁻¹° C.⁻¹ for the heat capacity of water, the present inventors obtain a field strength of 2.99×10³ V/m within the sample. Adjusting for the dielectric constant of water, 80, we obtain an estimate for the average electric field in the MW reactor of 2.39×10⁵ V/m. Given that the sample would have lost some heat to the sample vial and cooled somewhat prior to temperature measurement, this is a lower bound on the electric field strength, and acceptably close to the first value generated above to serve as an experimental verification. We therefore use the value derived from the Poynting vector, 3.5×10⁵ V/m, in the field emission estimates below.

The present inventors explore the possibility of field emission of electrons from the SWNT suspensions using a common version of the Fowler-Nordheim (F-N) equation (Equation. 13), which describes the tunneling current density through a triangular barrier from a conductor subject to a high electric field. The present inventors replace E with βE to account for the field amplification generated by the aspect ratio of the nanotubes, and assume that the emitter area α is 10⁻¹⁸ m² (roughly the cross-section of our SWNT). The effective field E at the surface of the SWNT tip is affected (decreased) by the relative dielectric constant k of its local environment. The present inventors use k=2.3, the dielectric constant of polyethylene (relative to vacuum permittivity), which should be representative of the alkyl ‘tail’ of the SDBS surfactant.

$$J = {K}_{1} \cdot {E}^{2} exp ( - \frac{{K}_{2}}{E} ) \\ {K}_{1} = 1.5413 \times {10}^{- 6} \frac{1}{Φ} \\ {K}_{2} = 6.828 \times {10}^{7} {Φ}^{\frac{3}{2}} \qquad ( 13 )$$

Inserting the constants, the amplification factor and the emitter area, gives

$$J = 1.5413 \times {10}^{- 6} \frac{1}{Φ} \cdot {( β E )}^{2} exp ( - \frac{6.828 \times {10}^{7} {Φ}^{\frac{3}{2}}}{β E} ) \qquad ( 14 )$$

TABLE 3

| Parameter | Variable | Value | Units |
|---|---|---|---|
| Poynting Vector | S | | [W/m²] |
| Power density | <S> | | [W/m²] |
| Electric field strength | E | | [V/m²] |
| Auxiliary magnetic field | H | | T |
| Magnetic field | B | | T |
| Permeability of free space | μₒ | 4π × 10⁻⁷ | [N/m²] |
| Permeability | M | 1.25 × 10⁻⁷ | [N/m²] |
| Relative Permeability | μᵣ | μ/μₒ | |
| | | 9.948 × 10⁻¹ | |
| Permittivity of free space | εₒ | 8.854 × 10⁻¹² | [F/m] |
| Permittivity | εₛ | 1 | [F/m] |
| Relative dielectric constant | εᵣ | εₛ/εₒ | |
| | | 1.13 × 10¹¹ | |
| Speed of light | c | 3 × 10⁸ | [m/s] |
| Current density | J | | [A/m] |
| Constants | K1, K2 | | |
| Potential barrier | Φ | 5 | [eV] |
| Amplification factor | β | | |

The present inventors first consider the case of a bare metallic SWNT. Since F-N emission is extremely non-linear, the present inventors utilize 1.414E, to capture the effect of the peak applied field strength (3.5×10⁵ V/m is the rms field strength E from above). The effective field strength is reduced by the dielectric constant of the medium immediately surrounding the nanotube; this is about 2.3 for a saturated hydrocarbon. The present inventors estimate that the minimum current needed to generate observable nanoparticles in 10 seconds to be at least 10⁻¹⁸ A (assuming an effective duty cycle of 10%, 100 atoms per particle and 3 e⁻ per atom), while the larger particles seen would require emission currents in the vicinity of 10⁻¹⁶-10⁻¹⁵ A.

Emission is highly sensitive to the choice of barrier height Φ; for experiments in vacuo, this is normally set to the work function of the emitter material, which for SWNT would be about 4.7 V. This is not a realistic choice for the present work, however. FIG. 24.a.a shows the expected emission current per SWNT tip, per the F-N equation, using the oxidation potential of a 1 nm diameter metallic SWNT as the barrier height (1.5 V) while varying the length of the tube, and thereby 0, which multiplies the applied field strength. The result indicates that only SWNT of several microns in length would generate detectable nanoparticles. This is contrary to the present inventors' observed results of finding particles commonly on SWNT down to a few hundred nm in length. FIG. 24.b.a shows the effect of varying the effective barrier height for 500 nm long nanotubes, and find that sufficient emission currents would be generated with effective barriers in the 0.25-0.30 V range. This value is not impossibly low, but seems unrealistic. Such anomalously low barriers may be attributable to (unidentified) low-lying intermediate states of oriented water and/or ionized species in the Helmholtz layer.

Next we consider the case where the SDBS surfactant monolayer ‘compresses’ most of the field gradient into the thin low-k region around the nanotube, as visualized in FIG. 1.a in the main text. This somewhat non-intuitive result is the consequence of a (series-connected) capacitive voltage divider network; if capacitors of dissimilar magnitude are so connected, most of any applied voltage appears across the smaller capacitor. The smaller capacitor is the (half) concentric spherical section bounded by the (assumed) hemispherical nanotube cap and the (assumed) hemispherical surfactant monolayer. In the case of a 1 nm dia. Nanotube, and a 3 nm thick surfactant layer, the resulting capacitances are ˜1.6×10⁻¹⁹ F (C=4π∈₀κ₂r₂) and 3.1×10⁻¹⁷ F (C=4λ∈₀κ₁/(r₁⁻¹−r₂⁻¹)), respectively (using κ₁=2.3 δ₀, κ₂=80 ∈₀, ∈₀=8.854×10⁻¹² F/m, r₁=0.5 nm, r₂=3.5 nm). Since the capacitance of the surfactant layer is ±100 times smaller, it will capture essentially all the potential drop in the system, just as FIG. 1.a indicates. We note in passing that this capacitance is sufficiently small that adding one electron to the tip of the nanotube (e.g. polarizing in the MW field) will raise its potential on the order of one volt; this can only enhance the probability of electron transfer reactions in this system.

This compression effect serves to increase the effective electric field strength at the SWNT tips even more than the geometric β factor, L/2D. In fact, the entire modulation potential, δU=EL/2, appears across the 3 nm thickness T of the surfactant layer at the tip of the SWNT (E′=δU/T=EL/2T). The concentric spherical geometry of the SWNT/surfactant tip structure further focuses the electric field at the SWNT tip by yet another factor, G=(r₂/r₁)². G varies significantly with nanotube diameter; if T is 3 nm for all SWNT, then for a tube with 1 nm diameter, G=49, and overall the field amplification is greater than 13 by a factor of 49/3˜16.3, which the present inventors will call Z*. Z* values are plotted for SWNT of various diameters in FIG. 24.c, assuming a surfactant 3 nm thick.

Thus armed, the present inventors return to Fowler-Nordheim estimates of field emission of 1 nm diameter SWNT coated with 3 nm of SDBS including the potential gradient compression factor Z*. In FIG. 24.a, curves (b) and (c), show the expected emission current assuming barriers of 4.7 V and 1.5 V, respectively. If the tunnel barrier is 4.7 V, then the short tubes never generate enough current to produce the nanoparticles we observe. With a barrier of 1.5 V, however, then the expected emission current is appropriate for short tubes (˜200 nm long) to produce nanoparticles, as observed experimentally. Similarly, trace (b) in FIG. 24.b shows emission current for 500 nm long SWNT (1 nm diameter) as a function of barrier height. Interestingly, barriers around 1.7 V should produce emission in the 10⁻¹⁵ A range, consistent with our experimentally observed deposition rates.

All numbers herein will be understood to be preceeded by the term “about”.

It will be understood that herein the term “includes” means “includes, but is not limited to.”

Although the invention has been described with reference to specific embodiments, these descriptions are not meant to be construed in a limiting sense. Various modifications of the disclosed embodiments, as well as alternative embodiments of the invention may become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims may cover any such modifications or embodiments that fall within the true scope of the invention.

What is claimed is:

1. A nanoscale composite structure, comprising:
a conductive nanorod comprising a tip at each of the nanorod extrema; and
a material deposited on at least one tip,
wherein the material comprises a reduced form of a redox species,
wherein the redox species is adapted for electrochemical reaction with the conductive nanorod when the conductive nanorod is stimulated as an antenna by an electric field.

2. The nanoscale composite structure according to claim 1, wherein the material comprises particles localized at each of the tips such that the structure comprises a dumbbell.

3. The nanoscale composite structure according to claim 1, wherein the material partially encapsulates the nanorod.

4. The nanoscale composite structure according to claim 1, wherein the material fully encapsulates the nanorod.

5. The nanoscale composite structure according to claim 1, wherein the structure comprises a ring comprising the nanorod.

6. The nanoscale composite structure according to claim 5, wherein the structure further comprises a second nanorod, wherein the second nanorod is connected to the ring such that the structure comprises a ring on a stick.

7. The nanoscale composite structure according to claim 1, wherein the structure comprises a split ring comprising the nanorod.

8. The nanoscale composite structure according to claim 1, wherein the material comprises a metal.

9. The nanoscale composite structure according to claim 1, wherein the redox species is electrochemically reactive with the conductive nanorod when the conductive nanorod is stimulated as an antenna by the electric field so as to generate solvated electrons.

10. The nanoscale composite structure according to claim 1, wherein the redox species is electrochemically reactive with the conductive nanorod in a solution when the conductive nanorod is stimulated as an antenna by the electric field so as to produce field emission into the solution.

11. The nanoscale composite structure according to claim 1, wherein the redox species is electrochemically reactive with the conductive nanorod when the conductive nanorod is stimulated as an antenna by the electric field in the presence of a surfactant in solution.

12. The nanoscale composite structure according to claim 11, wherein the surfactant comprises a low dielectric material and the solution comprises a high dielectric environment and wherein the redox species is electrochemically reactive with the conductive nanorod when the conductive nanorod is stimulated as an antenna by the electric field while coated with the surfactant.

13. The nanoscale composite structure according to claim 1, wherein the conductive nanorod comprises a metallic nanorod and wherein the redox species is preferentially electrochemically reactive with the metallic nanorod when the metallic nanorod is stimulated as an antenna by the electric field while in a mixture with a semiconducting nanorod.

14. The nanoscale composite structure according to claim 1, wherein the conductive nanorod comprises a conductive nanorod of a first diameter and wherein the redox species is preferentially electrochemically reactive with the conductive nanorod of the first diameter when the conductive nanorod of the first diameter is stimulated as an antenna by the electric field while in a mixture with a conductive nanorod of a second diameter, wherein the first diameter is larger than the second diameter.

15. The nanoscale composite structure according to claim 1, wherein the conductive nanorod comprises a single walled carbon nanotube.

16. A method for chemically modifying a conductive nanorod, said method comprising:
mixing a redox species with the conductive nanorod in a solution;
stimulating the conductive nanorod as an antenna with an electric field,
wherein the conductive nanorod comprises a tip at each of the nanorod extrema;
allowing the redox species to electrochemically react with the conductive nanorod when stimulating the conductive nanorod with the electric field; and
depositing a material comprising a reduced form of the redox species on the tips so as to form a nanoscale composite structure.

17. The method according to claim 16, wherein the redox species comprises a metal salt.

18. The method according to claim 16, wherein the method further comprises generating solvated electrons.

19. The method according to claim 16, wherein the method further comprises generating field emission into the solution.

20. The method according to claim 16, wherein the stimulating step comprises stimulating the conductive nanorod with the electric field in the presence of a surfactant in a solution.

21. The method according to claim 20, wherein the surfactant comprises a low dielectric material and the solution comprises a high dielectric environment and wherein the method comprises coating the nanorod with the surfactant.

22. The method according to claim 16, wherein the conductive nanorod comprises a metallic nanorod and the allowing step comprises allowing the redox species to preferentially electrochemically react with the metallic nanorod while in a mixture with a semiconducting nanorod.

23. The method according to claim 16, wherein the conductive nanorod comprises a conductive nanorod of a first diameter and the allowing step comprises allowing the redox species to preferentially electrochemically react with the conductive nanorod of the first diameter while in a mixture with a conductive nanorod of a second diameter, wherein the first diameter is larger than the second diameter.

24. The method according to claim 16, wherein the conductive nanorod comprises a single walled carbon nanotube.

25. The method according to claim 16, wherein the method comprises a step in a method for separating metallic nanorods from semiconducting nanorods.
